(19) United States
(12) Patent Application Publication
(10) Pub. No.: US 2004/0054515 A1
(43) Pub. Date: Mar. 18, 2004

(54) Methods and systems for modeling the performance of a processor

(76) Inventors: Rajat Kumar Todi, Santa Clara, CA (US); Stephanie L. Postal, Ft. Collins, CO (US); Robert J. Brooks, Ft. Collins, CO (US); Ted Scott Rakel, Ft. Collins, CO (US); Greg Alan Woods, San Jose, CA (US); Christopher J. Sadler, Ft. Collins, CO (US); Terry L. Lyon, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/247,162

(22) Filed: Sep. 18, 2002

(51) Int. Cl. G06F 9/45

(52) U.S. Cl. 703/22

(57) ABSTRACT

A method for modeling the performance of a test processor using a processor simulator program. The processor simulator program is configured for executing an application program against an input dataset. The method includes obtaining a plurality of representative samples, each of the plurality of representative samples representing a respective group of initial samples having substantially similar runtime performance characteristics. Each of the plurality of representative samples has a plurality of dynamic instructions, wherein dynamic instructions from the plurality of representative samples represents only a subset of a stream of dynamic instructions generated when the application program is executed against the input dataset. The stream of dynamic instructions is segmentable into a plurality of initial samples of which the respective group of initial samples is a subset. The method further includes obtaining a set of performance indicators from the processor simulator program. Each performance indicator in the set of performance indicators is obtained by executing a representative sample in the plurality of representative samples against the input dataset using the processor simulator program.

This application claims priority from a provisional application entitled “Reducing SPEC CPU2000 Workload Using Representative Examples,” Attorney Docket No. 200208418-1, Application No.______, filed on Sep. 11, 2002 by the inventors herein. The above-mentioned provisional application is incorporated by reference herein.

### BACKGROUND OF THE INVENTION

As is well known, a processor simulator is a software program that simulates its hardware processor counterpart. Processor simulators are often employed to predict the performance of a processor to be built and to evaluate design tradeoffs in order to optimize the processor design prior to fabrication.

Generally speaking, a simulator may operate in two modes: a functional mode (FM) and a microarchitecture (UA) mode. In the function mode, the simulator maintains the integrity of the translation look-aside buffer (TLB), caches, and certain statistics. In the more detailed UA mode, the simulator acts as a temporal simulator that maintains all or almost all microarchitecture state-by-state cycles, where TLB, caches, pipelines, cams, buffers, and the like, are all or almost all maintained. The UA mode is responsible for modeling a detailed microarchitecture implementation, collecting statistics, and reporting them. Many designers rely on the results from the more detailed temporal simulator, i.e., a simulator running in the UA mode, to evaluate the microarchitecture design since it is widely accepted that a temporal simulator is more accurate.

To facilitate discussion, FIG. 1 shows an exemplary temporal simulation environment 100, including a temporal simulator 102. Temporal simulator 102 takes as its input a set of microarchitecture design parameters 104, representing the design parameters that define the performance of a particular microprocessor. The size of an L1 cache may represent a design parameter inputted into temporal simulator 102, for example. Temporal simulator 102 also takes as inputs an application file 106, along with an input dataset 108, both of which are executed on temporal simulator 102 in order to generate an output 110. Output 110 contains information indicative of the performance of the microprocessor simulated by temporal simulator 102. By iteratively varying various design parameters in the set of microarchitecture design parameters 104 and running the input application program 106 against input dataset 108 on temporal simulator 102, it is possible to analyze the set of data outputs 110 and to ascertain the most desirable tradeoff in the design parameters, as well as to spot any potential problem with the design.

It is known, however, that there is an enormous runtime cost associated with evaluating processor performance using a highly accurate temporal simulator. This is partly because the software simulator operates on the application program and data inputted at a vastly slower speed than that of its hardware counterpart. For example, there exists in the art a benchmark application program known as SPEC's CPU2000 (herein “SPEC2K”), available from www.spec.org/osg/cpu2000/. Like most benchmark programs, SPEC2K aims to normalize the performance measurement of various processors, thereby allowing users to compare the performance of different processors using a standard measure. On an actual hardware platform, such as computer employing an 800 MHz Itanium-family processor (available from Intel Corporation of Santa Clara, Calif.), the SPEC2K Vortex benchmark may complete in a matter of minutes. Running in the full UA mode, a detailed temporal simulator simulating an IA-64 processor may require nearly 10 days to complete the same Vortex benchmark. As another point of data, running in the full UA mode, a detailed temporal simulator simulating an IA-64 processor may require nearly two years to complete the full SPEC2K benchmark.

Since it is highly advantageous to obtain the performance data from a processor simulator prior to committing to fabricating the processor itself, attempts have been made to reduce the runtime cost of temporal simulation. One approach to reducing the amount of time required to simulate a processor in the UA mode employs reduced datasets. FIG. 2 illustrates this approach, wherein dataset 108 of FIG. 1 is replaced by a reduced dataset 202 of FIG. 2. In the reduced dataset approach, the input dataset is reduced, generally by taking only a percentage of the original dataset, while preserving the execution profile. A paper entitled “Adapting the SPEC benchmark suite for simulation based computer architecture research” by A. KlenOsowski, J. Flynn, N., Mearves, and D. Lilja (Proceedings of the Third IEEE Annual Workshop on Workload Characterization, pages 73-82, September 2000) discusses one implementation of the aforementioned reduced dataset approach.

However, the reduced dataset approach may, in some cases, fail to exercise certain simulated hardware features as well as can be accomplished using the full input dataset. Thus after the performance data is acquired and extrapolated, the result may be quite different from the performance data achievable using the full input dataset. In order to maintain high accuracy, a fairly large reduced dataset may be required, which may unduly lengthen the required simulation time. Furthermore, the reduced dataset approach requires an understanding of each application program (e.g., application program 106 in FIG. 2) in order to produce a reliable reduced input dataset.

Other approaches to reducing the amount of time required to simulate a processor in the UA mode involve time sampling of the original dataset, which may be uniform sampling or random sampling. This approach is shown in FIG. 3. In FIG. 3, the original dataset 108 is employed as an input into temporal simulator 102. However, only certain samples of the full dataset 108 is employed for simulation purposes. The selection of the samples are governed by a sampling policy 302, which may implement uniform sampling or random sampling. In one implementation of uniform sampling, a fixed-sized UA sample (i.e., a fixed number of continuous dynamic instructions) is selected from the stream of dynamic instructions every fixed time interval. For example, a uniform sample of 10,000 dynamic instructions may be obtained after 100,000 dynamic instructions running in the low-cost FM mode are executed. In one implementation of random time sampling, a UA sample (either fixed-sized or random-sized) is selected from the full input dataset at random time intervals. For example, a sample of 10,000 dynamic instructions may be obtained after a random number of dynamic instructions running in the low-cost FM mode is executed.

It has been found, however that the time sampling technique also has certain disadvantages. For example, certain application programs may distribute its workload unevenly over time. In this case, the time sampling technique, relying on the passage of time as a selection criterion for the input dataset samples, may not produce an accurate simulation result. To sample the full dataset with reasonable accuracy, a large number of samples may be required, which may again unduly lengthen the simulation time.

Another approach to reducing the amount of time required to simulate a processor in the UA mode involves the use of both a reduced dataset and time sampling. This approach is shown in FIG. 4 in which both the reduced input dataset 404 and the time sampling policy 406 are employed as inputs into temporal simulator 102. In this case, it is possible to further reduce the simulation time. However, the hybrid technique of FIG. 4 does not address the inaccuracies inherent in either the reduced dataset technique or the time sampling technique. Further, the hybrid technique of FIG. 4 may suffer compound errors from both the reduced dataset technique and the time sampling technique.

### SUMMARY OF THE INVENTION

The invention relates, in one embodiment, to a method for modeling the performance of a test processor using a processor simulator program. The processor simulator program is configured for executing an application program against an input dataset. The method includes obtaining a plurality of representative samples, each of the plurality of representative samples representing a respective group of initial samples having substantially similar runtime performance characteristics. Each of the plurality of representative samples has a plurality of dynamic instructions, wherein dynamic instructions from the plurality of representative samples represents only a subset of a stream of dynamic instructions generated when the application program is executed against the input dataset. The stream of dynamic instructions is segmentable into a plurality of initial samples of which the respective group of initial samples is a subset. The method further includes obtaining a set of performance indicators from the processor simulator program. Each performance indicator in the set of performance indicators is obtained by executing a representative sample in the plurality of representative samples against the input dataset using the processor simulator program.

In another embodiment, the invention relates to an article of manufacture comprising a program storage medium having computer readable code embodied therein. The computer readable code is configured for modeling the performance of a test processor using a plurality of computers executing a plurality of simulator programs. Each of the plurality of simulator programs simulates the test processor and is configured for executing an application program against an input dataset. There is includedcomputer readable code for receiving a plurality of representative samples, each of the representative samples having a plurality of dynamic instructions and an associated weight. The plurality of dynamic instructions represents a subset of a stream of dynamic instructions generated by an earlier execution of the application program against the input dataset on a reference processor that is mappable to the test processor. The plurality of dynamic instructions is executable by at least one of the plurality of simulator programs. There is also included computer readable code for executing the plurality of representative samples against the input dataset on the plurality of computers, thereby obtaining a set of performance indicators.

In yet another embodiment, the invention relates to an arrangement for modeling the performance of a test processor using a processor simulator program. The processor simulator program is configured for executing an application program and an input dataset. There is included means for executing the application program and the input dataset on a reference processor. The reference processor represents a processor that is mappable to the test processor. The executing the application program and the input dataset on the reference processor includes generating a stream of dynamic instructions segmentable into a plurality of initial samples. There is additionally included means for ascertaining a plurality of performance data vectors from the executing the application program and the input dataset on the reference processor. Each performance data vector of the plurality of performance data vectors has a plurality of performance metrics associated with executing dynamic instructions associated with a respective one of the plurality of initial samples. There is further included means for ascertaining a plurality of representative samples from the plurality of performance data vectors. A total number of representative samples in the plurality of representative samples is smaller than a total number of performance data vectors in the plurality of performance data vectors. Each representative sample of the plurality of representative samples has an associated sample weight. the each representative sample includes a plurality of dynamic instructions. Additionally, there is included means for obtaining a set of performance indicators from the processor simulator program using the plurality of representative samples. Each performance indicator in the set of performance indicators is obtained by executing a representative sample in the plurality of representative samples against the input dataset in the processor simulator program.

In another embodiment, the invention relates to a method for modeling the performance of a test processor using a processor simulator program. The processor simulator program is configured for executing an application program against an input dataset. The method includes executing the application program against the input dataset on a reference processor, the reference processor representing a processor that is mappable to the test processor. The executing the application program against the input dataset on the reference processor includes generating a stream of dynamic instructions segmentable into a plurality of initial samples. The method includes Obtaining a plurality of performance data vectors from the executing the application program against the input dataset on the reference processor. Each performance data vector of the plurality of performance data vectors has a plurality of performance metrics associated with executing dynamic instructions associated with a respective one of the plurality of initial samples. The method additionally includes obtaining a plurality of representative samples from the plurality of performance data vectors, a total number of representative samples in the plurality of representative samples being smaller than a total number of performance data vectors in the plurality of performance data vectors. Each representative sample of the plurality of representative samples has an associated sample weight, the each representative sample including a plurality of dynamic instructions. The method also includes obtaining a set of performance indicators from the processor simulator program using the plurality of representative samples. Each performance indicator in the set of performance indicators is obtained by executing a representative sample in the plurality of representative samples against the input dataset in the processor simulator program. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

To facilitate discussion, FIG. 1 shows an exemplary temporal simulation environment, including a temporal simulator.

FIG. 2 illustrates the reduced dataset approach to improving performance modeling speed.

FIG. 3 illustrates the time-sampling approach to improving performance modeling speed.

FIG. 4 illustrates the hybrid reduced dataset/time-sampling approach to improving performance modeling speed.

FIG. 5 illustrates, in accordance with one embodiment of the present invention, a simplified flow diagram showing the improved performance modeling technique.

The segmentation of exemplary dynamic instructions that are generated from the execution of an application against an input dataset is illustrated in FIG. 6 in accordance with one embodiment of the present invention.

FIG. 7 shows an example illustrating the exemplary performance data vectors in accordance with one embodiment of the present invention.

FIG. 8 illustrates, in accordance with one embodiment of the present invention, an exemplary reduction in the number of variables for the performance data vectors of FIG. 6.

FIG. 9 illustrates, in accordance with one exemplary implementation, the representation of the set of performance data vectors by the set of representative performance data vectors through the use of cluster analysis.

FIG. 10 illustrates, in accordance with one exemplary implementation, the exemplary samples ascertained from the representative performance data vectors.

FIG. 11 illustrates, in accordance with one exemplary implementation, an example of how a weighted performance indicator may be calculated.

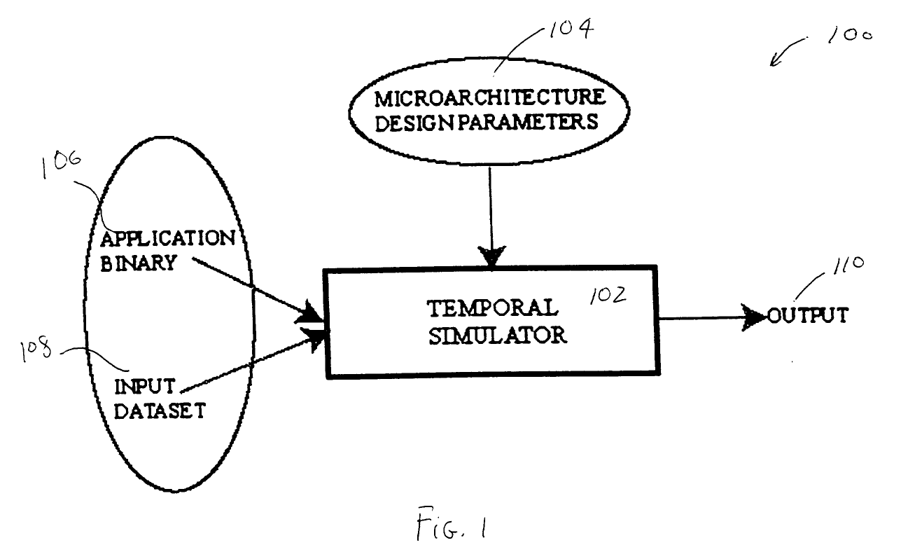

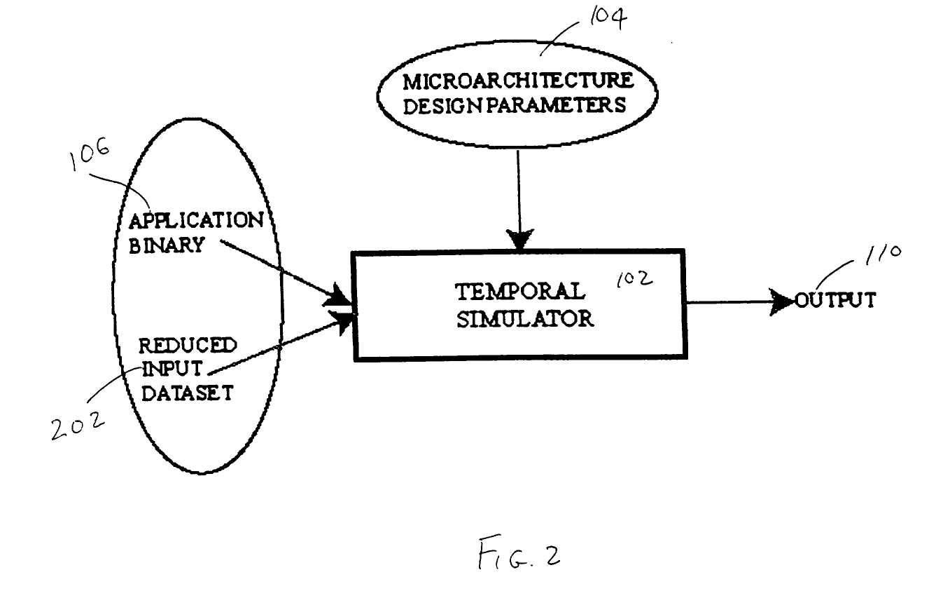

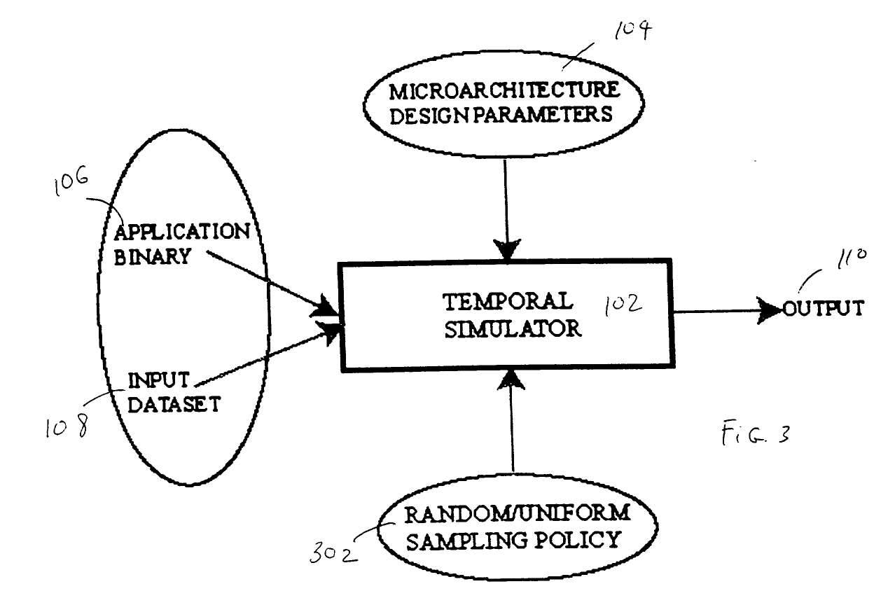

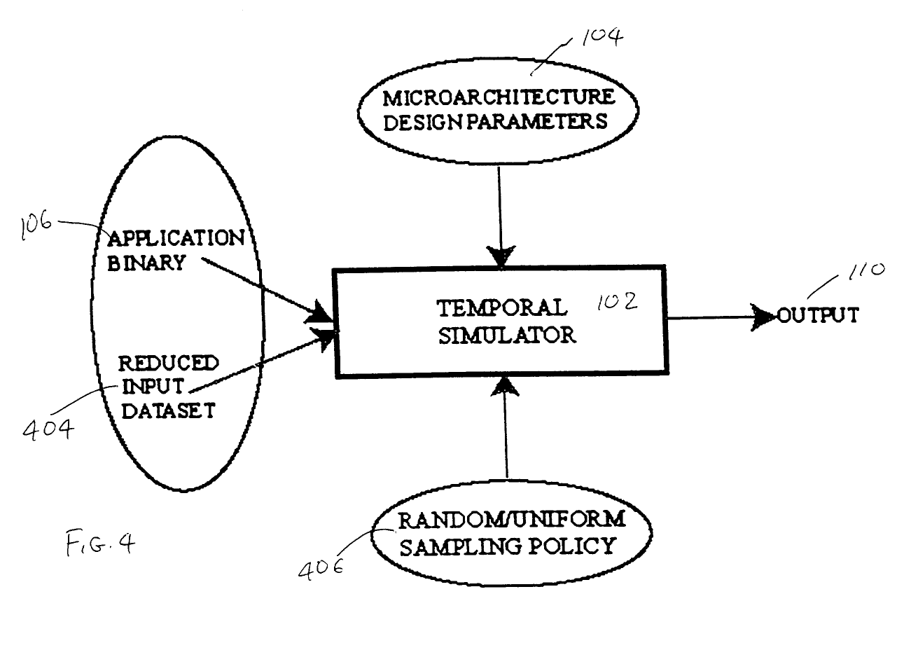

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The invention relates, in one embodiment, to methods and apparatus for efficiently and accurately ascertaining the performance data of a target processor from its simulator program. As the term is employed herein, the target processor represents the processor being simulated by the simulator program. For example, if a processor design engineer wishes to assess the performance of a given processor design, the engineer may execute a given application program (such as a benchmark program) against a given input dataset using the simulator program. If the simulation is accurate, the performance data would closely match the performance of the target processor after fabrication.

In one embodiment, the invention involves obtaining a set of initial samples from the stream of dynamic instructions that is generated by executing the application program against the input dataset on a reference processor. Each initial sample may be constructed by, for example, obtaining the group of dynamic instructions contained in every few seconds or minutes of execution time.

It is recognized by the inventors herein that most processor designs involve incremental changes to an existing processor. Accordingly, it is possible to leverage performance characteristics obtained from an existing processor and employ those performance characteristics in the simulation of a test processor. In so doing, the invention takes advantage of the ability of an existing reference processor to quickly execute the application program and the input dataset at the high hardware speed in order to quickly obtain a set of performance data vectors for the set of initial samples.

In general, a reference processor represents an existing processor that is mappable to the target processor under simulation. A reference processor is said to be mappable to the target processor if computer instructions for executing on the reference processor can be translated or otherwise converted into computer instructions for executing on the target processor. In the typical case, the reference processor may represent a processor in the same architecture family as the target processor, albeit with different capabilities. That is, the reference processor employs the same base instruction set and is in the same generation with the target processor, albeit having a different speed or a different capability.

For example, there exist in the marketplace processors employing the X86 base instruction set, which is available from Intel Corporation of Santa Clara, Calif. Processors employing this base instruction set includes processors known by their trade names as 8086, 80286, 80386, 486, Pentium, Itanium, McKinley, and the like. An earlier version of an Itanium processor may serve as a reference processor for a later version of an Itanium test processor, as they both employ the same base instruction set (X86) and are in the same generation, even though one may be faster or may have different capabilities (e.g., different clock speeds and/or different cache sizes). A 486 processor may also serve as a reference processor for a Pentium target processor since they employ the same base instruction set (X86), albeit in different generations. Further, an AMD K5 processor (AMD Corporation of Sunnyvale, Calif.) may also serve as a reference processor for an Intel-based Pentium or Itanium processor. To improve accuracy, it is preferable to select a reference processor having capabilities and features as close as possible to those of the target processor.

Furthermore, a processor running an instruction set different from the aforementioned X86 base instruction set may serve as a reference processor for a target X86 processor if the computer instructions executable on the reference processor can be converted into computer instructions executable on the target processor. Other base instruction sets also exist (e.g., 68000-based) and similar considerations apply.

Since the reference processor is a hardware-based processor, the application program and the associated input dataset may be completed relatively quickly, generally orders of magnitude faster than can be completed on the simulator program. Each outputted performance data vector includes a plurality of variables, each of which is indicative of a particular performance metrics of the reference processor. In general, an outputted performance data vector corresponds to an initial sample. Thus, there are as many outputted performance data vectors as there are initial samples.

An outputted performance data vector may be simplified so as to reduce redundant information among its variables. It is recognized by the inventors herein that in a data vector with many variables, groups of variables often move together. This is because multiple variables may be measuring the same driving principle governing the performance characteristic of the reference processor. By simplifying in each outputted performance data vector, it is possible to substantially reduce redundancy to improve computational efficiency without unduly impacting the accuracy of the simulation.

The simplified set of performance data vectors are then reduced by grouping. In grouping, groups of similar or substantially similar performance data vectors are replaced by representative performance data vectors and associated weights. For example, if five different performance data vectors are represented by the first representative performance data vector, its weight would be 5. If three different performance data vectors are represented by another representative performance data vector, its weight would be 3. Each representative performance data vector corresponds to one initial sample, although there are of course fewer representative performance data vectors than there are performance data vectors and initial samples due to grouping/clustering.

The representative performance data vectors may then be used to obtain their counterpart samples, which are known as representative samples. Each representative sample is one of the initial samples, albeit one that represents other initial samples. Since there are fewer representative performance data vectors than there are initial samples due to grouping/clustering, there are thus fewer representative samples.

The representative samples, each of which may contain a plurality of dynamic instructions, are then executed using the software-based simulator program. Since there are fewer representative samples than there are initial samples, the simulator program is able to complete its task in a shorter amount of time. The execution of the representative samples using the simulator program generates a set of performance indicators, with each performance indicator corresponding to a representative sample.

The outputted set of performance indicators are then extrapolated, using the weights associated with their respective representative samples. That is, each performance indicator is multiplied or scaled by the weight associated with its respective representative sample. The extrapolated performance indicators are then summed, generating a weighted performance indicator, which is indicative of the performance of the test processor being simulated.

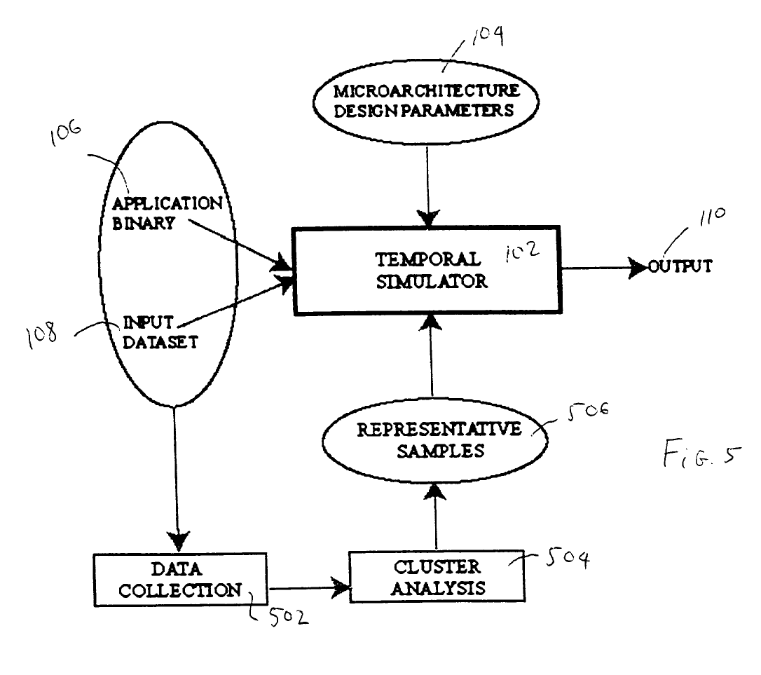

The features and advantages of the present invention may be better understood with reference to the drawings and discussion that follow. FIG. 5 illustrates, in accordance with one embodiment of the present invention, a simplified flow diagram showing the improved performance modeling technique. In FIG. 5, the full input dataset is employed. However, prior to simulation, data collection step 502 is performed. Data collection of performance data is performed when application 106 is executed against input dataset 108 on the reference processor. The goal of the data collection step is to obtain a plurality of performance data vectors for a plurality of initial samples, with each sample containing a plurality of dynamic instructions from the execution of application 106 against input dataset 108 on the reference processor.

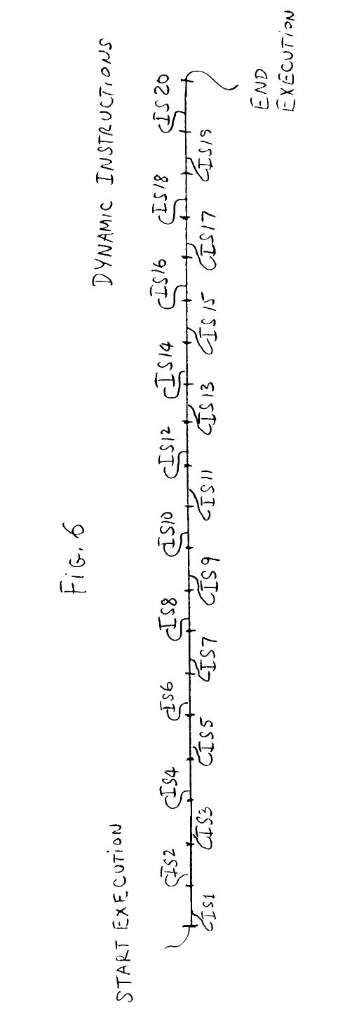

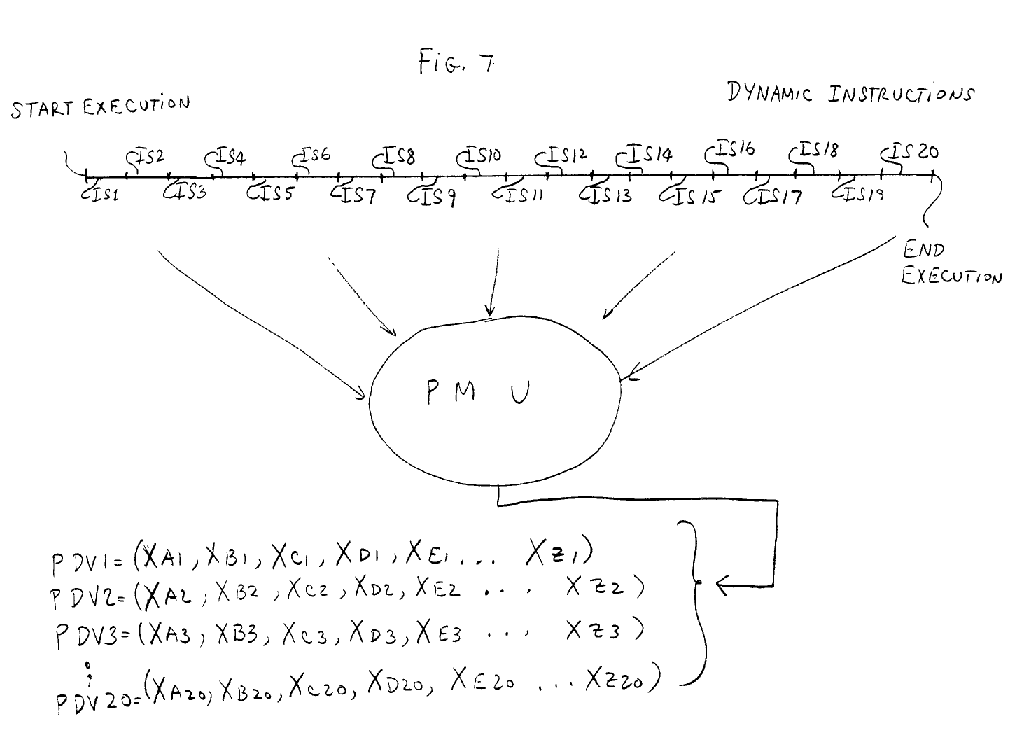

In this data collection step, the reference processor is employed since it is much faster to execute on a hardware-based processor. Even though the reference processor may not be (and is often not) exactly identical to the test processor under simulation, the inventors herein recognize that the “new” test processor is often an incremental design change from the previous reference processor. Thus, the incremental difference between the two processors may result in a sample selection error that is small relative to other simulation-related errors. The selection error may be reduced further by choosing a larger number of representative samples. Accordingly, it is felt and has subsequently been proved that this approach is acceptable in view of the speed/accuracy tradeoff. The data collection step 502 is further discussed in connection with FIGS. 6-7 herein.

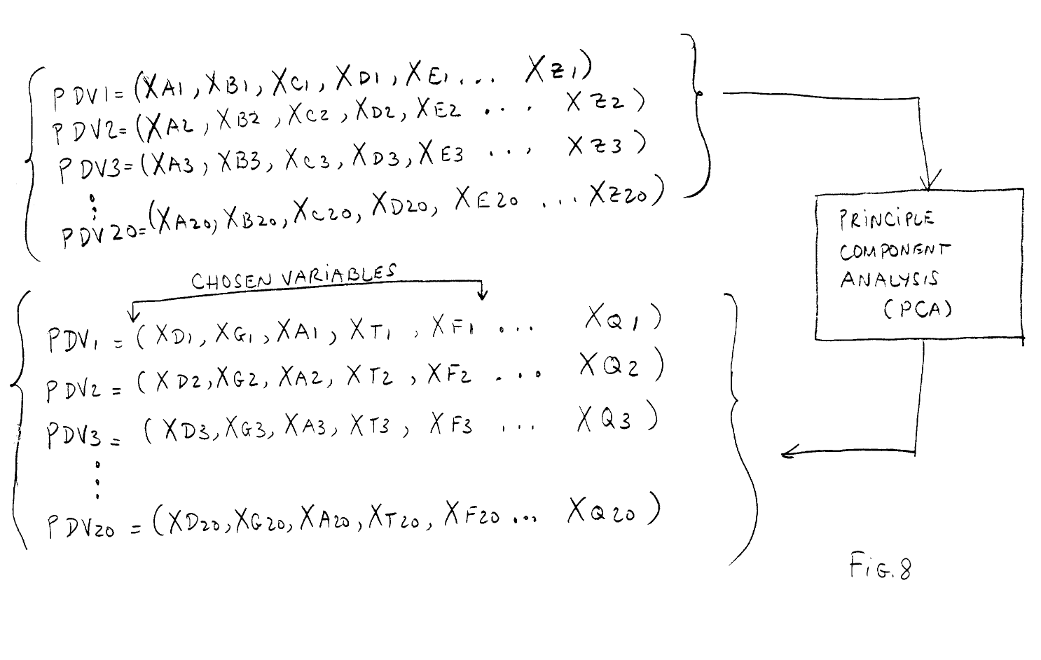

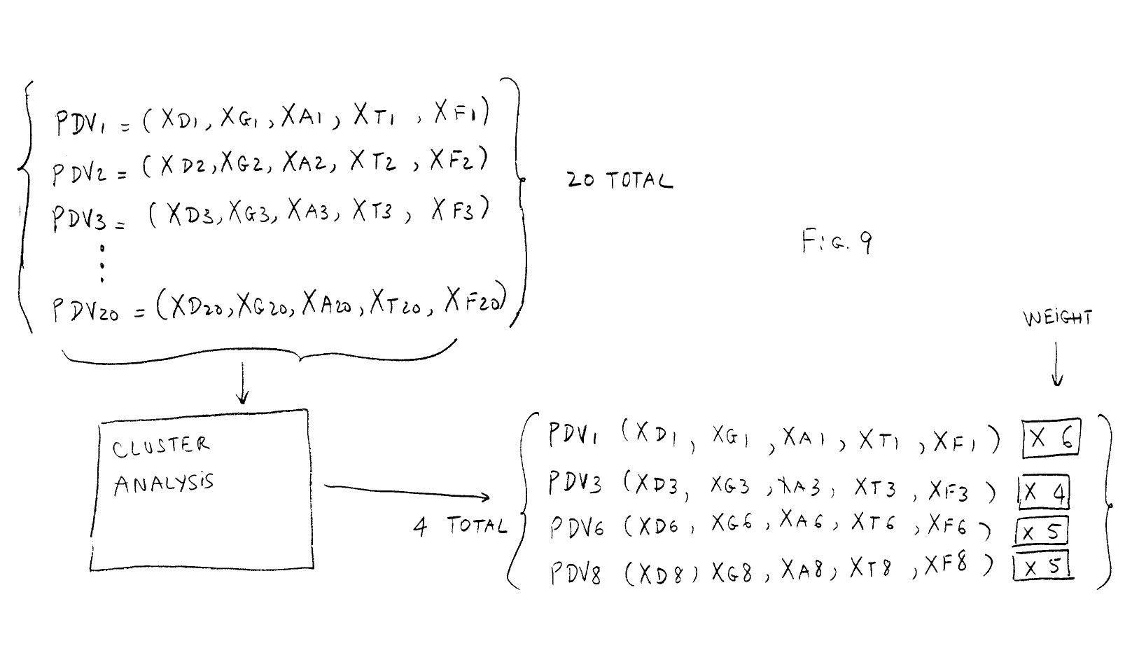

The performance data vectors are then further processed in the grouping/clustering analysis step 504. In this step, the performance data vectors are grouped to generate a plurality of sample performance data vectors and their respective weights. As mentioned earlier, in grouping, a group of similar or substantially similar performance data vectors is replaced by a representative performance data vector and a weight factor that represents how many performance data vectors the sample performance data vector replaces. As the term is employed herein, a group of initial samples is deemed to have substantially similar runtime performance characteristics if their respective performance data vectors are grouped and represented by a representative performance data vector. The exact groupings of course depend on how much accuracy is desired and/or other parameters. There are refinements that substantially improve the efficiency of the grouping/clustering task. Details of the grouping/clustering analysis step along with efficiency-related refinements are discussed further in FIGS. 8-9 herein.

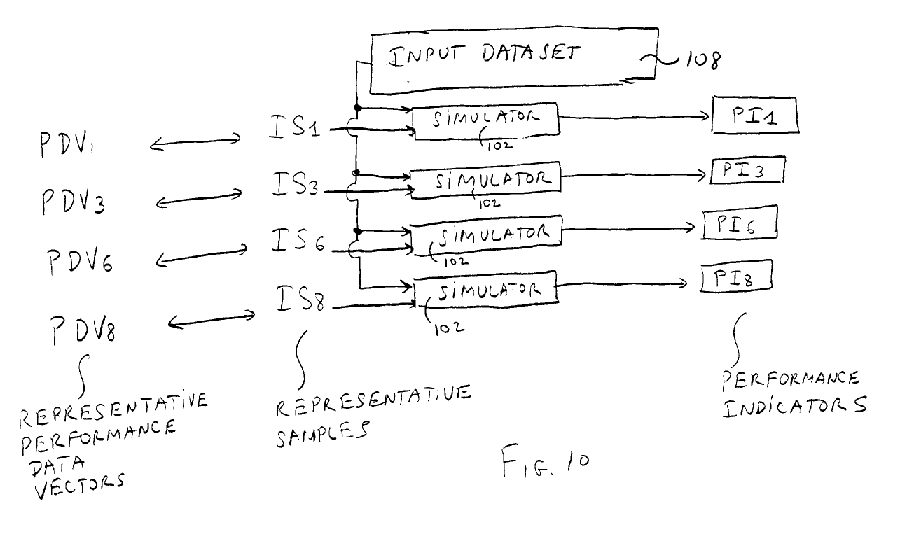

The representative performance data vectors are then employed to select corresponding representative samples in step 506. Step 506 is discussed in details later herein in FIG. 10.

The representative samples generated from step 506, along with their corresponding weights, are employed as inputs into temporal simulator 102. Temporal simulator 102 executes these representative samples against input data set 108, and obtains an output 110, which represents a weighted performance indicator indicative of the performance of the test processor under simulation.

FIGS. 6 and 7 show the data collection step 502 in greater detail. As mentioned earlier, in data collection, the application 106 and input dataset 108 are first executed on a reference processor to obtain a plurality of performance data vectors. In one embodiment, application 106 and input dataset 108 are allowed to execute on a reference processor, and the dynamic instructions that are generated during execution are segmented into initial samples, each of which contains a plurality of dynamic instructions.

In one embodiment, the initial samples are obtained by time sampling the dynamic instructions. For example, if it takes 0.2 minute to complete the execution of application 106 and input dataset 108 on a reference processor, and twenty samples are desired, each initial sample may contain the dynamic instructions for 0.01 second of execution.

The segmentation of the dynamic instructions that are generated from the execution of application 106 on input dataset 108 into initial samples is illustrated in FIG. 6. In the example of FIG. 6, the twenty million dynamic instructions are divided into twenty samples of 1 million dynamic instructions each (labeled IS₁, IS₂, IS₃, . . . IS₂₀).

Furthermore, data pertaining to performance during the execution of application 106 and input data 108 may be collected for each sample. The performance data may be collected using a PMU (Performance Monitoring Unit). By way of example, the performance may be collected using a product known as Caliper™, available from the Hewlett-Packard Company of Palo Alto, Calif. The performance data for each sample is typically a vector comprising a plurality of variables, with each variable being indicative of a performance metrics of the reference processor when executing the application 106 against input dataset 108. FIG. 7 shows in details four exemplary performance data vectors PDV₁, PDV₂, PDV₃, and PDV₂₀, which are obtained for initial samples IS₁, IS₂, IS₃, and IS₂₀ of FIG. 6 (performance data vectors PDV₄-PDV₁₉ are not shown to simplify the drawing).

A few comments regarding the initial sampling process may be in order. As discussed above, the initial sample sizes are uniform. However, in other embodiments, the initial sample sizes of the different initial samples may be non-uniform if desired. Further, the initial samples of the exemplary embodiment are collected by time-sampling sequential blocks of dynamic instructions. However it is also possible to collect the initial samples by non-uniform sampling or other methods of sampling which result in non-overlapping blocks of dynamic instructions (uniform or non-uniform in sizes).

With respect to size, generally speaking, the smaller the initial sample size, the more accurate the simulation result tends to be. However, there comes a point where the error due to initial sample sizing is small relative to the error contributed by using a different processor as the reference processor or other simulation-related error. Small initial sample sizes increase the workload of the subsequent analysis, and certain PMUs may become unreliable analyzing extremely small sample sizes. Thus, a tradeoff between sample size, accuracy, and PMU reliability is required. In one embodiment, a sample size of 10 million dynamic instructions works well for the aforementioned Caliper PMU when executing the SPEC2K benchmark and dataset.

In one embodiment, the data collection step is validated. In validation, the entire set of dynamic instructions associated with application program 106 and input dataset 108 is executed in the reference processor and the performance data therefor is obtained. The initial samples, each of which contains a plurality of dynamic instructions, are then executed on the reference processor against the input dataset 108, and the set of performance data associated with the execution of the initial samples is obtained. By summing up the performance data for individual initial samples and comparing the two sets of performance data obtained, the relative error caused by dividing the dynamic instructions into samples may be noted. The designer may then change the sample size or sample methodology to reduce the error. Since the executions are performed on the hardware-based reference processor, this validation process, which may be iterative, can be performed relatively quickly.

FIGS. 8-9 illustrate, in one embodiment of the invention, an implementation of step 504 (cluster analysis) in greater detail. In cluster analysis, the goal is to reduce the number of performance data vector while preserving most of the variance characteristics. In one embodiment, the performance data vectors are optionally processed to reduce the number of variables in each vector. Recalling from FIG. 6 that each performance data vector contains a plurality of variables, each of which is indicative of a performance metrics of the reference processor executing the application 106 against input dataset 108. For example, one or more of these variables may reflect the floating point count. As another example, one or more of these variables may reflect the cache miss.

It is recognized by the inventors herein that many variables in a performance data vector may directly or indirectly measure the same performance characteristic. Thus, there is redundancy in the information provided by the full set of variables in each performance data vector. If the number of variables is reduced while preserving most of the variance information, a great deal of efficiency may be achieved in subsequent analysis steps.

In one embodiment, the reduction in the number of variables in the performance data vectors is achieved by applying principal component analysis (PCA). In PCA, the variables in each performance data vectors are analyzed and sorted by its variance percentage. Once the variables are sorted by their variance percentages, a subset of the variables may be selected if that subset reflects a sufficiently high variance percentage. In one embodiment, it is preferable that the subset of variables selected reflects at least 80% of the total variance. In another embodiment, 90% of the total variance is preserved. In general, the higher the percentage of variance preserved, the larger the number of variables included in the subset for subsequent analysis, and the greater the processing burden in subsequent analysis steps that involve the aforementioned variables. Other techniques of reduction may also be applied, alternatively or additionally. In one embodiment, independent component analysis (ICA) is employed.

The reduction in the number of variables for the performance data vectors of FIG. 6 is symbolically illustrated in FIG. 8. In FIG. 8, the original variables X_{AN}-X_{ZN} is reordered based on their variance percentages (N is a number from 1-20). Thus, variable X_{DN} is considered in the example as reflecting the greatest variance percentage, followed by variables X_{GN}, X_{AN}, X_{TN}, X_{FN} and lastly XQN, which reflects the least variance percentage among the variables of FIG. 8. In this example, the first five variables X_{DN}, X_{GN}, X_{AN}, X_{TN}, and X_{FN} contain 90% of the variance information and are thus selected to comprise the subset of reduced variables. The resultant set of performance data vectors with reduced variables are shown in FIG. 8.

The optional reduction step for the variables is helpful during the grouping/clustering analysis. In grouping analysis, multivariate statistical analysis is performed on the performance data vectors to replace the original set of performance data vectors with a set of representative performance data vectors. This type of grouping/clustering analysis may be accomplished using the software tool MATLAB (available from www.matlab.com, Sep. 17, 2002). There are fewer members in the set of representative performance data vectors compared to the set of performance data vectors. With reference to the present example, grouping analysis reduces the current 20 performance data vectors to, for example, 4 representative performance data vectors. Each representative performance data vector is a member of the set of performance data vectors, albeit one which represents one or more other performance data vectors in the set of representative performance data vectors.

FIG. 9 illustrates, in accordance with one exemplary implementation, the representation of the set of performance data vectors by the set of representative performance data vectors through the use of cluster analysis. Since the number of variables was reduced in the optional variable reduction step, the grouping/clustering analysis is performed on fewer variables, advantageously reducing the amount of time and memory required to perform the grouping/clustering analysis. Further, since the variables that remain contain most of the variance information, the loss in accuracy is minimal relative to the gain in speed and efficient memory utilization.

Grouping/clustering analysis may be analogized to setting up post offices in a planned city. Suppose a planned city has 100,000 plots of land for housing/business development. Five plots need to be set aside for post offices. The problem becomes how to best group the 100,000 plots into five separate zones so that the distance from the plots in each zone to the post office therein can be minimized. Returning now to the problem at hand, in the example of FIG. 9, the K-mean algorithm is employed for grouping similar or substantially similar vectors. K-mean is a well known algorithm and is only one of many algorithms that can be employed for cluster analysis, all of which may be employed herein. The number of groups can be specified in advance, or may be determined after grouping in view of the groups formed. The goal again is to maximize accuracy while keeping the number of representative performance data vectors as low as possible. In this example, the set of 20 vectors is reduced to four vectors PDV₁, PDV₃, PDV₆, and PDV₈.

Representative performance data vector PDV₁ represents, for example, six vectors: PDV₁, PDV₂, PDV₁₀, PDV₁₂, PDV₁₇, and PDV₁₉. Since PDV₁ represents six other vectors of the set of reduced variable performance data vectors, it is given a weight of 6 as shown in FIG. 9.

Representative performance data vector PDV₃ represents, for example, four vectors: PDV₃, PDV₄, PDV₅, and PDV₁₅. Since PDV₃ represents four other vectors of the set of reduced variable performance data vectors, it is given a weight of 4 as shown in FIG. 9.

Representative performance data vector PDV₆ represents, for example, 5 vectors: PDV₆, PDV₇, PDV₉, PDV₁₃, and PDV₁₄. Since PDV₆ represents 5 other vectors of the set of reduced variable performance data vectors, it is given a weight of 5 as shown in FIG. 9.

Representative performance data vector PDV₈ represents, for example, 5 vectors: PDV₈, PDV ₁₁, PDV₁₆, PDV₁₈, and PDV₂₀. Since PDV₈ represents 5 other vectors of the set of reduced variable performance data vectors, it is given a weight of 5 as shown in FIG. 9.

Note that although each performance data vector represents in FIG. 9 multiple other vectors, the vector chosen from the set of represented vectors (which are found by grouping or cluster analysis) is preferably the vector corresponding to the initial sample that is executed first in time. Thus, with respect to representative performance data vector PDV₃ for example, its corresponding initial sample IS₃ is the first that is executed relative to the initial samples IS₄, IS₅, and IS₁₆ that correspond to the other represented vectors. Accordingly, performance data vector PDV₃ is chosen. As will be discussed later herein, this strategy offers advantages in term of simulation efficiency.

Once the representative PDVs are found, their corresponding initial samples are ascertained. In this example, the corresponding initial samples are IS₁, IS₃, IS₆, and IS₈. This is illustrated in FIG. 10. These samples are now representative samples in the sense that they capture most of the dominant run time characteristics of the program. That is, their dynamic instructions capture most of the run time characteristics of the application program 106 when these representative samples are executed against the input dataset 108. Note that the sum of all the dynamic instructions in the set of representative samples is only a subset of the stream of dynamic instructions generated when the application program 106 is executed against the input dataset 108. This reduction in the number of dynamic instructions that need to be executed for performance modeling purposes in one important advantage of the present invention.

Thereafter, these initial samples IS₁, IS₃, IS₆, and IS₈ are executed on temporal simulator 102 against the full input dataset 108 as shown in FIG. 10. Since only a subset of all the dynamic instructions is executed, it is possible to substantially reduce the time required to simulate the test processor.

Each of the representative samples has an associated weight, which is equal to the weight accorded its respective representative performance data vector. From a runtime behavior perspective, the weight accorded each representative sample reflects the runtime behavior of the program. A representative sample having a larger weight factor has a higher frequency of repetition during execution than to a representative sample having a lower weight factor.

In one embodiment, a snapshot of the FM mode parameters and/or cache contents is taken in order to improve the efficiency of the later simulation runs. For example, the entire stream of dynamic instructions may be executed with the representative samples being executed in the full UA mode and the remainder being executed in a less costly mode, such as the aforementioned FM mode or a fast-forward mode in which there is little if any cache warm up and/or architecture simulation. Snapshots are taken of the FM mode parameters and/or cache contents prior to the execution of each representative sample.

These snapshots are then employed during subsequent simulation runs (e.g., in subsequent simulation runs wherein when the designer varies parameters in microarchitecture design parameter 104 and obtains performance information related to these experimental scenarios). For example, the snapshot information may allow the cache to be populated with the appropriate data prior to the execution of a representative sample. The snapshot information facilitates this without requiring the execution of the preceding dynamic instructions again (in either the FM or UA mode). If the cache was not “warmed” properly and the execution of a given representative sample was performed as if that representative sample were the first initial sample in the stream of dynamic instructions, the performance data obtained would have been misleading since, for example, more cache miss would be experienced than would have been experienced had that representative sample been executed in series with preceding dynamic instructions of the preceding samples.

In one embodiment, the representative samples are executed on a single machine running the temporal simulator program 102. In another embodiment, the representative samples are executed on separate machines running the temporal simulator program 102. Thus, the execution of the representative samples can be performed in parallel, further cutting down on the simulation time. If a sufficient number of parallel machines is employed for simulation, it is possible to simulate the performance of a given test processor using the inventive technique herein in a shorter amount of time than the amount of time required to execute the same application program and associated input dataset on an actual hardware processor.

Furthermore, there is provided in one embodiment of the invention software for acquiring the representative samples and for executing the representative samples on a plurality of computers running copies of the simulator program 102 in parallel. By automating these tasks, it is possible to simplify and substantially reduce the amount of time required to model processor performance during what-if scenarios with different microarchitecture parameters.

Since each representative sample is preferably the initial sample that is executed first relative to other initial samples in the group that it represents, efficiency is improved since the simulation can be stopped as soon as the instructions in all representative samples are executed. If the representative sample is chosen from a later initial sample in each group (e.g., if PDV₂₀ had been chosen to be the representative performance data vector in the fourth group instead of PDV₈, and its corresponding initial sample IS₂₀ had been chosen as the representative sample instead of IS₈), the simulation may have to be executed longer than necessary otherwise.

The execution of the representative samples against input dataset 108 on simulator 102 results in a set of performance indicators. In FIG. 10, these performance indicators for the representative samples are illustrated by labels PI₁, PI₃, PI₆, and PI₈.

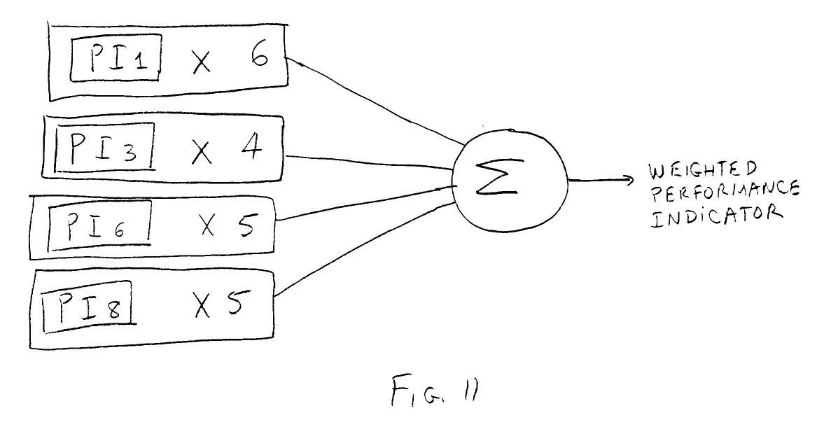

The performance indicator obtained from executing each representative sample is then scaled or multiplied by its respective weight, and summed with others to obtain a weighted performance indicator. With reference to FIG. 11, performance indicator PI₁ is multiplied by a weight factor of 6 (associated with performance data vector PDV₁ as shown in FIG. 9). Similarly, performance indicator PI₃ is multiplied by a weight factor of 4, performance indicator PI₆ by a weight factor of 5, and performance indicator PI₈ by a weight factor of 5. The resultant weighted performance indicator from the scaling-and-summing operation represents the projected performance of the simulator and approximates the performance that the simulator program would have yielded if the simulator program had executed all dynamic instructions related to application 106 and the full input dataset 108.

In one embodiment, the performance result is validated against the result obtained by executing all dynamic instructions related to application 106 and the full input dataset 108 on simulator 102. The execution of application 106 against the full input dataset 108 on simulator 102 may be performed on a single machine, or initial samples may be performed on multiple parallel machines using the snapshot data technique discussed earlier. Although the execution of all dynamic instructions related to application 106 and the full input dataset 108 may be time-consuming, this collection of snapshot data needs to be done only once. This validation may reveal the relative error caused by the present inventive technique of simulation by representative sampling. The designer may choose to modify the initial sample size and/or initial sampling methodology, the variable reduction algorithm, the grouping/clustering algorithm, or other parameters associated with the present invention to try to reduce the error. Alternatively or additionally, the designer may simply note that the same error will also affect other simulation runs employing different sets of microarchitecture design parameters. Since many designers are primarily interested in the relative performance change between simulation runs, the existence of such an error, if relatively consistent across all the simulation runs, may be immaterial to the designer.

As can be appreciated from the foregoing, the invention employs the full input dataset for simulation. Accordingly, the invention advantageously avoids the input data sampling error associated with prior art techniques. Further, although the invention involves sampling the dynamic instructions obtained by executing application program 106 against input data set 108 (i.e., the full input dataset) and collecting the performance data therefor, the use of a reference processor, with its hardware speed, substantially reduces the time required for such data collection.

As another advantage, there is no need for an in-depth understanding of the source code of the application program 106 and/or input data set 108. In the present invention, the dynamic instructions are simply sectioned into initial samples without requiring an in-depth knowledge of either the application program and/or the input dataset. As mentioned earlier in connection with one embodiment, the initial samples may be selected on a criterion as simple as execution duration on the reference processor.

By grouping and selecting the dynamic samples so as to preserve as much of the runtime characteristics as possible, the invention allows the simulation to be executed on a smaller number of dynamic instructions without unduly compromising accuracy. Through the use of the grouping/clustering algorithm and the use of dynamic instructions for the initial samples, the probability that critical runtime characteristics are missed by the representative samples is substantially reduced. Additionally, even though the representative dynamic instruction samples are employed instead of the full stream of dynamic instructions, the projection error is substantially minimized through the use of the weight factors.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for modeling the performance of a test processor using a processor simulator program, said processor simulator program being configured for executing an application program against an input dataset, comprising:
obtaining a plurality of representative samples, each of said plurality of representative samples representing a respective group of initial samples having substantially similar runtime performance characteristics, each of said plurality of representative samples having a plurality of dynamic instructions, wherein dynamic instructions from said plurality of representative samples represents only a subset of a stream of dynamic instructions generated when said application program is executed against said input dataset, said stream of dynamic instructions being segmentable into a plurality of initial samples of which said respective group of initial samples is a subset; and
obtaining a set of performance indicators from said processor simulator program, each performance indicator in said set of performance indicators being obtained by executing a representative sample in said plurality of representative samples against said input dataset using said processor simulator program.

2. The method of claim 1 wherein said runtime performance characteristics is determined by executing said application program against said input dataset on a reference processor that is mappable to said test processor.

3. The method of claim 2 wherein said obtaining said plurality of representative samples further comprises obtaining a plurality of performance data vectors from said executing said application program against said input dataset using said reference processor, each performance data vector of said plurality of performance data vectors having a plurality of performance metrics associated with executing dynamic instructions associated with a respective one of said plurality of initial samples.

4. The method of claim 3 wherein a total number of representative samples in said plurality of representative samples being smaller than a total number of performance data vectors in said plurality of performance data vectors.

5. The method of claim 4 wherein each representative sample of said plurality of representative samples has an associated sample weight reflective of a number of initial samples represented by said each representative sample.

6. The method of claim 5 further comprising
obtaining a weighted performance indicator from said set of performance indicators, said obtaining said weighted performance indicator including multiplying each performance indicator in said set of performance indicators with a sample weight associated with a respective representative sample employed earlier to obtain said each performance indicator.

7. The method of claim 4 wherein said obtaining said set of performance indicators further comprises obtaining a plurality of representative performance data vectors, said plurality of representative performance data vectors representing a subset of said plurality of performance data vectors after said plurality of performance data vectors is reduced.

8. The method of claim 7 wherein said plurality of performance data vectors is reduced using cluster analysis to obtain said plurality of representative performance data vectors.

9. The method of claim 8 further comprising using only a subset of said plurality of performance metrics in said performance data vectors to obtain said representative performance data vectors.

10. The method of claim 9 wherein said subset of said plurality of performance metrics is ascertained using principal component analysis.

11. The method of claim 9 wherein said subset of said number of performance metrics is ascertained using independent component analysis.

12. The method of claim 2 wherein said reference processor and said test processor are in the same architecture family, said reference processor having one of a different speed or a different capability compared to a specification of said test processor.

13. An article of manufacture comprising a program storage medium having computer readable code embodied therein, said computer readable code being configured for modeling the performance of a test processor using a plurality of computers executing a plurality of simulator programs, each of said plurality of simulator programs simulating said test processor and being configured for executing an application program against an input dataset, comprising:
computer readable code for receiving a plurality of representative samples, each of said representative samples having a plurality of dynamic instructions and an associated weight, said plurality of dynamic instructions representing a subset of a stream of dynamic instructions generated by an earlier execution of said application program against said input dataset on a reference processor that is mappable to said test processor, said plurality of dynamic instructions being executable by at least one of said plurality of simulator programs; and
computer readable code for executing said plurality of representative samples against said input dataset on said plurality of computers, thereby obtaining a set of performance indicators.

14. The article of manufacture of claim 13 further comprising computer readable code for obtaining a weighted performance indicator from said set of performance indicators and respective weights associated with individual ones of said plurality of representative samples.

15. The article of manufacture of claim 13 wherein computer readable code for executing said plurality of representative samples against said input dataset on said plurality of computers is configured to execute said plurality of representative samples against said input dataset on said plurality of computers in parallel.

16. The article of manufacture of claim 13 further comprising:
computer readable code for receiving a plurality of snapshot datasets, each of said plurality of snapshot datasets including information pertaining to system parameters relevant to said test processor prior to executing one of said plurality of representative samples, each of said plurality of snapshot datasets being associated with one of said plurality of representative samples; and
computer readable code for setting parameters associated with at least a subset of said plurality of plurality of simulator programs responsive to data from said plurality of snapshot datasets.

17. The article of manufacture of claim 16 wherein said setting said parameters includes setting parameters pertaining to a cache content.

18. The article of manufacture of claim 13 wherein said application program represents a benchmark program.

19. The article of manufacture of claim 18 wherein said benchmark program is SPE15K.

20. The article of manufacture of claim 13 wherein said plurality of representative samples is obtained using cluster analysis.

21. The article of manufacture of claim 15 wherein said plurality of dynamic instructions associated with each representative sample of said plurality of representative samples represents dynamic instructions based on an X86 instruction set.

22. An arrangement for modeling the performance of a test processor using a processor simulator program, said processor simulator program being configured for executing an application program and an input dataset, comprising:
means for executing said application program and said input dataset on a reference processor, said reference processor representing a processor that is mappable to said test processor, said executing said application program and said input dataset on said reference processor includes generating a stream of dynamic instructions segmentable into a plurality of initial samples;
means for ascertaining a plurality of performance data vectors from said executing said application program and said input dataset on said reference processor, each performance data vector of said plurality of performance data vectors having a plurality of performance metrics associated with executing dynamic instructions associated with a respective one of said plurality of initial samples;
means for ascertaining a plurality of representative samples from said plurality of performance data vectors, a total number of representative samples in said plurality of representative samples being smaller than a total number of performance data vectors in said plurality of performance data vectors, each representative sample of said plurality of representative samples having an associated sample weight, said each representative sample including a plurality of dynamic instructions; and
means for obtaining a set of performance indicators from said processor simulator program using said plurality of representative samples, each performance indicator in said set of performance indicators being obtained by executing a representative sample in said plurality of representative samples against said input dataset in said processor simulator program.

23. The arrangement of claim 22 further comprising
means for obtaining a weighted performance indicator from said set of performance indicators, said obtaining said weighted performance indicator including multiplying each performance indicator in said set of performance indicators with a sample weight associated with a respective representative sample employed earlier to obtain said each performance indicator.

24. The arrangement of claim 22 wherein said obtaining said set of performance indicators further comprises obtaining a plurality of representative performance data vectors, said plurality of representative performance data vectors representing a subset of said plurality of performance data vectors after said plurality of performance data vectors is reduced.

25. The arrangement of claim 24 wherein said plurality of performance data vectors is reduced using cluster analysis to obtain said plurality of representative performance data vectors.

26. The arrangement of claim 24 wherein said representative data samples are obtained from said plurality of representative performance data vectors, each representative data sample in said plurality of representative data samples corresponds to a representative data vector in said plurality of representative data vectors, each of said representative data samples corresponds to one initial sample of said plurality of initial samples.

27. The arrangement of claim 25 wherein only a subset of said plurality of performance metrics in said performance data vectors is employed to obtain said representative performance data vectors.

28. The arrangement of claim 22 further comprising using only a subset of said number of performance metrics in said performance data vectors to obtain said obtaining said representative samples.

29. The arrangement of claim 28 wherein said subset of said number of performance metrics is ascertained using principal component analysis.

30. The arrangement of claim 28 wherein said subset of said number of performance metrics is ascertained using independent component analysis.

31. The arrangement of claim 22 wherein said reference processor and said test processor are in the same architecture family.

32. The arrangement of claim 31 wherein said architecture family represents an X86-based architecture family.

33. The arrangement of claim 22 wherein said reference processor and said test processor are in different architecture families.

34. The arrangement of claim 33 wherein said reference processor belongs to a given generation of an X86-based architecture, said test processor belongs to a next generation of said X86-based architecture, said next generation of said X86 architecture being developed later in time than said given generation of said X86-based architecture.

35. The arrangement of claim 22 wherein said reference processor is hardware-based.

36. The arrangement of claim 22 wherein a weight associated with a given representative sample of said plurality of representative samples is indicative of a number of initial samples in said plurality of initial samples being represented by said given representative sample in said plurality of representative samples.

37. The arrangement of claim 22 wherein said obtaining said plurality of performance data vectors includes employing a performance monitoring unit (PMU) to monitor said executing said application against said input dataset on said reference processor.

38. The arrangement of claim 22 wherein said performance monitor unit is Caliper™.

39. The arrangement of claim 22 wherein said application program is a benchmark program.

40. The arrangement of claim 39 wherein said benchmark program is SPEC2K.

41. A method for modeling the performance of a test processor using a processor simulator program, said processor simulator program being configured for executing an application program against an input dataset, comprising:
executing said application program against said input dataset on a reference processor, said reference processor representing a processor that is mappable to said test processor, said executing said application program against said input dataset on said reference processor includes generating a stream of dynamic instructions segmentable into a plurality of initial samples;
obtaining a plurality of performance data vectors from said executing said application program against said input dataset on said reference processor, each performance data vector of said plurality of performance data vectors having a plurality of performance metrics associated with executing dynamic instructions associated with a respective one of said plurality of initial samples;
obtaining a plurality of representative samples from said plurality of performance data vectors, a total number of representative samples in said plurality of representative samples being smaller than a total number of performance data vectors in said plurality of performance data vectors, each representative sample of said plurality of representative samples having an associated sample weight, said each representative sample including a plurality of dynamic instructions; and
obtaining a set of performance indicators from said processor simulator program using said plurality of representative samples, each performance indicator in said set of performance indicators being obtained by executing a representative sample in said plurality of representative samples against said input dataset in said processor simulator program.

42. The method of claim 41 further comprising
obtaining a weighted performance indicator from said set of performance indicators, said obtaining said weighted performance indicator including multiplying each performance indicator in said set of performance indicators with a sample weight associated with a respective representative sample employed earlier to obtain said each performance indicator.

43. The method of claim 41 wherein said obtaining said set of performance indicators further comprises obtaining a plurality of representative performance data vectors, said plurality of representative performance data vectors representing a subset of said plurality of performance data vectors after said plurality of performance data vectors is reduced.

44. The method of claim 43 wherein said plurality of performance data vectors is reduced using cluster analysis to obtain said plurality of representative performance data vectors.

45. The method of claim 43 wherein said representative data samples are obtained from said plurality of representative performance data vectors, each representative data sample in said plurality of representative data samples corresponds to a representative data vector in said plurality of representative data vectors, each of said representative data samples corresponds to one initial sample of said plurality of initial samples.

46. The method of claim 44 further comprising using only a subset of said plurality of performance metrics in said performance data vectors to obtain said representative performance data vectors.

47. The method of claim 41 further comprising using only a subset of said plurality of performance metrics in said performance data vectors to obtain said obtaining said representative samples.

48. The method of claim 47 wherein said subset of said plurality of performance metrics is ascertained using principal component analysis.

49. The method of claim 47 wherein said subset of said plurality of performance metrics is ascertained using independent component analysis.

50. The method of claim 41 wherein said reference processor and said test processor are in the same architecture family.

51. The method of claim 50 wherein said architecture family represents an X86-based architecture family.

52. The method of claim 41 wherein said reference processor and said test processor are in different architecture families.

53. The method of claim 52 wherein said reference processor belongs to a given generation of an X86-based architecture, said test processor belongs to a next generation of said X86-based architecture, said next generation of said X86 architecture being developed later in time than said given generation of said X86-based architecture.

54. The method of claim 41 wherein said reference processor is hardware-based.

55. The method of claim 41 wherein a weight associated with a given representative sample of said plurality of representative samples is indicative of a number of initial samples in said plurality of initial samples being represented by said given representative sample in said plurality of representative samples.

56. The method of claim 41 wherein said obtaining said plurality of performance data vectors includes employing a performance monitoring unit (PMU) to monitor said executing said application against said input dataset on said reference processor.

57. The method of claim 41 wherein said performance monitor unit is Caliper™.

58. The method of claim 41 wherein said application program is a benchmark program.

59. The method of claim 58 wherein said benchmark program is SPEC2K.

60. The method of claim 41 further comprising employing a plurality of computers to execute copies of said processor simulator program, wherein said plurality of computers is employed to execute in parallel at least a subset of said plurality of representative samples against said input dataset to obtain at least a subset of said plurality of performance indicators in parallel.

61. The method of claim 41 further comprising:
receiving a plurality of snapshot datasets, each of said plurality of snapshot datasets including information pertaining to system parameters relevant to an execution of one of said plurality of representative samples prior to executing said one of said plurality of representative samples; and
setting parameters relevant to an execution of a given representative sample of said plurality of representative samples using data in one of said plurality of snapshot datasets prior to executing said given representative sample against said input dataset.

62. The method of claim 61 wherein said setting said parameters includes setting parameters pertaining to a cache content.

63. The method of claim 41 wherein a given representative sample represents a given group of initial samples having substantially similar runtime performance characteristics, said given representative sample representing an initial sample in said given group of initial samples that is executed first in time relative to other initial samples in said given group of initial samples.
